(19) United States
(12) Patent Application Publication
(10) Pub. No.: US 2024/0282319 A1
(43) Pub. Date: Aug. 22, 2024

(54) IMPROVED STABILITY OF INTER-CHANNEL TIME DIFFERENCE (ITD) ESTIMATOR FOR COINCIDENT STEREO CAPTURE

(71) Applicant: Telefonaktiebolaget LM Ericsson (publ), Stockholm (SE)

(72) Inventors: Erik NORVELL, Upplands Väsby (SE); Tomas Jansson TOFTGÅRD, Uppsala (SE)

(21) Appl. No.: 18/568,713

(22) PCT Filed: Jun. 15, 2021
(86) PCT No.: PCT/EP2021/066159

§ 371 Date: Dec. 8, 2023

(51) Int. Cl. G10L 19/008

(52) U.S. Cl. CPC G10L 19/008

(57) ABSTRACT

A method and apparatus to identify coincident microphone configurations, CC, and adapt an inter-channel time difference, ITD, search, in an encoder or a decoder is provided. The method includes for each frame m of a multi-channel audio signal: generating a cross-correlation of a channel pair of the multi-channel audio signal; determining a first ITD estimate based on the cross-correlation; determining if the multi-channel audio signal is a CC signal; and responsive to determining that the multi-channel audio signal is a CC signal, biasing the ITD search to favor ITDs close to zero to obtain a final ITD.

### TECHNICAL FIELD

The present disclosure relates generally to communications, and more particularly to methods and related encoders and decoders supporting audio encoding and decoding.

### BACKGROUND

Spatial or 3D audio is a generic formulation which denotes various kinds of multi-channel audio signals. Depending on the capturing and rendering methods, the audio scene is represented by a spatial audio format. Typical spatial audio formats defined by the capturing method (microphones) are for example denoted as stereo, binaural, ambisonics, etc. Spatial audio rendering systems (headphones or loudspeakers) are able to render spatial audio scenes with stereo (left and right channels 2.0) or more advanced multichannel audio signals (2.1, 5.1, 7.1, etc.).

Recent technologies for the transmission and manipulation of such audio signals allow the end user to have an enhanced audio experience with higher spatial quality often resulting in a better intelligibility as well as an augmented reality. Spatial audio coding techniques, such as MPEG Surround or MPEG-H 3D Audio, generate a compact representation of spatial audio signals which is compatible with data rate constraint applications such as streaming over the internet for example. The transmission of spatial audio signals is however limited when the data rate constraint is strong and therefore post-processing of the decoded audio channels is also used to enhance the spatial audio playback. Commonly used techniques are for example able to blindly up-mix decoded mono or stereo signals into multi-channel audio (5.1 channels or more).

In order to efficiently render spatial audio scenes, the spatial audio coding and processing technologies make use of the spatial characteristics of the multi-channel audio signal. In particular, the time and level differences between the channels of the spatial audio capture are used to approximate the inter-aural cues which characterize our perception of directional sounds in space. Since the inter-channel time and level differences are only an approximation of what the auditory system is able to detect (i.e. the inter-aural time and level differences the ear entrances), it is of high importance that the inter-channel time difference is relevant from a perceptual aspect. The inter-channel time and level differences (ICTD and ICLD) are commonly used to model the directional components of multi-channel audio signals while the inter-channel cross-correlation (ICC)—that models the inter-aural cross-correlation (IACC)—is used to characterize the width of the audio image. Especially for lower frequencies the stereo image may as well be modeled with inter-channel phase differences (ICPD).

Note that the binaural cues relevant for spatial auditory perception are called inter-aural level difference (ILD), inter-aural time difference (ITD) and inter-aural coherence or correlation (IC or IACC). When considering general multichannel signals, the corresponding cues related to the channels are inter-channel level difference (ICLD), inter-channel time difference (ICTD) and inter-channel coherence or correlation (ICC). Since the spatial audio processing mostly operates on the captured audio channels, the “C” is sometimes left out and the terms ITD, ILD and IC are also used when referring to audio channels.

FIG. 1 illustrates a conventional setup employing parametric spatial audio analysis. A stereo signal pair is input to the stereo encoder 110. The spatial analyzer 112 aids the down-mixer 114, which produces a single channel representation of the two input channels. The down-mix process aims to compensate the channel differences in time, correlation and phase, thereby maximizing the energy of the down-mix signal. This achieves an efficient encoding of the stereo signal. The down-mixed signal is forwarded to a down-mix encoder 116. The parameters from the spatial analysis in encoded by the parameter encoder 118 and transmitted to the decoder together with the encoded down-mix. Usually some of the stereo parameters are represented in spectral sub-bands on a perceptual frequency scale such as the equivalent rectangular bandwidth (ERB) scale. The stereo decoder 120 performs a stereo synthesis in the spatial synthesizer 126 based on the signal from the downmix decoder 124 and the parameters from the parameter decoder 122. The stereo synthesis operation aims to restore the channel difference in time, level, correlation and phase, yielding a stereo image which resembles the input audio signal.

Since the encoded parameters are used to render spatial audio for the human auditory system, the inter-channel parameters can be extracted and encoded with perceptual considerations for maximized perceived quality.

Stereo and multi-channel audio signals are complex signals that can be difficult to model especially when the environment is noisy or reverberant or when various audio components of the mixtures overlap in time and frequency i.e. noisy speech, speech over music or simultaneous talkers, etc.

When it comes to estimating the ICTD, the conventional parametric approach relies on the cross-correlation function (CCF) r_{xy} which is a measure of similarity between two waveforms x(n) and y(n), and is generally defined in the time domain as

$${r}_{x y} ( n , τ ) = E [ x ( n ) y ( n + τ ) ]$$

where τ is the time-lag parameter and E[⋅] is the expectation operator. For a signal frame of length N the cross-correlation is typically estimated as

$${r}_{x y} ( τ ) = {\sum }_{n = 0}^{N - 1} x ( n ) y ( n + τ )$$

The ICC is conventionally obtained as the maximum of the CCF which is normalized by the signal energies in accordance with

$$ICC = {max}_{τ = ITD} ( \frac{{r}_{x y} ( τ )}{\sqrt{{r}_{xx} ( 0 ) {r}_{y y} ( 0 )}} )$$

The time lag τ corresponding to the ICC is determined as the ICTD between the channels x and y. The CCF may also be calculated using the Discrete Fourier Transform as

$${r}_{x y} ( τ ) = {DFT}^{- 1} ( X ( k ) Y * ( k ) )$$

where X[k] is the discrete Fourier transform (DFT) of the time domain signal x[n], Y*[k] is the complex conjugate of the discrete Fourier transform (DFT) of the time domain signal y[n], i.e.

$$\begin{matrix}X ( k ) = {\sum }_{n = 0}^{N - 1} x ( n ) {e}^{- i \frac{2 π}{N} k n} , & k = 0 , … , N - 1 \\ Y * ( k ) = {\sum }_{n = 0}^{N - 1} y ( n ) {e}^{i \frac{2 π}{N} k n} , & k = 0 , … , N - 1\end{matrix}$$

and the DFT⁻¹ (⋅) or IDFT (⋅) denotes the inverse discrete Fourier transform. It should however be noted that the DFT replicates the analysis frame into a periodic signal, yielding a circular convolution of x(n) and y(n). Based on this, the analysis frames are typically padded with zeros to match the true cross-correlation.

For the case when y(n) is purely a delayed version of x(n), the cross-correlation function is given by

$${r}_{x y} ( τ ) = {DFT}^{- 1} ( X ( k ) X * ( k ) {e}^{- i \frac{2 π}{N} k {τ}_{0}} ) = {r}_{xx} ( τ ) * δ ( τ - {τ}_{0} ) ,$$

where * denotes convolution and δ(τ−τ₀) is the Kronecker delta function, i.e. it is equal to one at τ₀ and zero otherwise. This means that the cross-correlation function between x and y is the delta function spread by the convolution with rₓₓ(τ), which is the autocorrelation function for x(n). For signal frames with several delay components, e.g. several talkers, there will be peaks at each delay present between the signals, and the cross correlation becomes

$${r}_{x y} ( τ ) = {r}_{xx} ( τ ) * {\sum }_{i} δ ( τ - {τ}_{i} ) .$$

The delta functions might then be spread into each other and make it difficult to identify the several delays within the signal frame. There are however generalized cross-correlation (GCC) functions that do not have this spreading. The GCC is generally defined as

$${r}_{xy}^{G C C} ( τ ) = D F {T}^{- 1} ( ψ ( k ) X ( k ) Y * ( k ) )$$

where ψ[k] is a frequency weighting. For spatial audio, the phase transform (PHAT) has been utilized due to its robustness for reverberation in low noise environments. The phase transform is basically the absolute value of each frequency coefficient, i.e.

$$ψ ( k ) = \frac{1}{\vert X ( k ) Y * ( k ) \vert} .$$

This weighting will thereby whiten the cross-spectrum such that the power of each component becomes equal. With pure delay and uncorrelated noise in the signals x[n] and y[n] the phase transformed GCC (GCC-PHAT) becomes just the Kronecker delta function δ(τ−τ₀), i.e.

$${r}_{xy}^{PHAT} ( τ ) = D F {T}^{- 1} ( \frac{X ( k ) X * ( k ) {e}^{- i \frac{2 π}{N} k {τ}_{0}}}{\vert X ( k ) X * ( k ) \vert} ) = D F {T}^{- 1} ( {e}^{- i \frac{2 π}{N} k {τ}_{0}} ) = δ ( τ - {τ}_{0} )$$

FIG. 2 illustrates a signal pair with inter-channel time difference, their cross-correlation and generalized cross-correlation with phase transform analysis for a pure delay situation.

In a real scenario analyzing a recorded stereo signal, the channels will not differ only by delay but will e.g. have different noise, variations in frequency response of the microphone and recording equipment and likely have different reverberation patterns. In this case the time lag τ is typically found by locating the maximum of the GCC-PHAT. In such situations, the analysis is further likely to show variation from frame to frame. This is a typical property in the short-term Fourier analysis, but also because the source signal may vary in level and spectral content which is the case e.g. for voice recordings. For this reason, it is beneficial to apply stabilization in the final analysis of the time lag. This may be done by slowing down or preventing the update of the time lag when the signal energy is low in relation to the background noise.

In U.S. Application Publication No. 2020/0194013A1, the ITD selection is stabilized by applying an adaptive low-pass filter of the GCC-PHAT. Low-pass filtering is applied on the cross-correlation by adaptively filtering the cross-correlation of consecutive frames. A low-pass filter is also applied on the time domain representation of the cross-correlation. For clean signals where the estimated signal-to-noise ratio (SNR) is high, a higher degree of low-pass filtering is used.

U.S. Application Publication No. US20200211575A1 describes a method to reuse a previously stored ITD value depending on SNR estimation, thereby achieving an ITD parameter which is more stable over time.

Time lags between channels in stereo recordings come from the physical distance between the microphones. As illustrated in FIG. 3, the AB microphone configuration typically has a relatively large distance between the microphones, around 1-1.5 meters. Hence, recordings using an AB configuration often have time delays between the channels, depending on the positions of the captured audio sources. Some microphone configurations, such as XY and MS, attempt to position the microphone membranes as close to each other as possible, so called coincident microphone configurations. These coincident microphone configurations typically have very small or zero time delay between the channels. The XY configuration captures the stereo image mainly through level differences. The MS setup, short for Mid-Side, has a mid channel directed to the front and a microphone with a figure-of-eight pickup pattern to capture the ambience in the side channel. The Mid-Side representation is transformed into a Left-Right representation using the relation

$$\{ \begin{matrix}L = M + S \\ R = M - S\end{matrix}$$

where the side channel S is added to the left and right channels with opposite sign. More generally, stereo representations may be obtained by transforming two or more mono signals into stereo representation, where the time difference between the signals (which relates to the physical distance of a capture) should be small. Another example of a suitable capture technique is the use of a tetrahedral microphone with four closely spaced cardioids from which a stereo representation may be formed.

### SUMMARY

For MS coincident microphone configurations (hereinafter called “coincident configurations”, and abbreviated as “CC”), the time lags should ideally be close to zero at all times. However, due to reverberation and noise, occasional time lags may be detected. If the time lag is encoded in the context of a stereo or multichannel audio encoder, a sudden jump in time lag caused by an erroneously detected lag can give an unstable impression of the location of the audio source in the reconstructed audio signal. Further, incorrect or unstable time lags will have a negative impact on the down-mix signal, which may exhibit unstable energy as a result of these errors.

Even if low-pass filtering of the GCC-PHAT is applied as suggested in US20200194013A1, the detection of an erroneous ITD in CC signals may happen. The ability to reuse a previously stored ITD value as outlined in US20200211575A1 does not safeguard against erroneous ITD estimations in CC signals. In fact, the added stabilization may make an erroneous decision persist even longer.

Certain aspects of the disclosure and their embodiments may provide solutions to these or other challenges. Various embodiments of inventive concepts described herein detect coincident configurations, e.g. of the MS microphone configuration. If such configurations are detected (e.g., the MS microphone configuration), the time lag detection may be adapted such that time lags closer to zero are favored.

According to some embodiments of inventive concepts, a method to identify coincident microphone configurations, CC, and adapt an inter-channel time difference, ITD, search, in an encoder or a decoder is provided. The method includes for each frame m of a multi-channel audio signal, generating a cross-correlation of a channel pair of the multi-channel audio signal. The method includes determining a first ITD estimate based on the cross-correlation. The method includes determining if the multi-channel audio signal is a CC signal. The method includes responsive to determining that the multi-channel audio signal is a CC signal, biasing the ITD search to favor ITDs close to zero to obtain a final ITD.

Analogous apparatus, computer program, and computer program products are provided in other embodiments of inventive concepts.

Advantages that can be achieved enable stabilizing the time lag or ITD detection, which improves the encoding quality and stability of the reconstructed audio of stereo signals of coincident configurations, e.g. from an MS configuration. Stabilizing the time lag or ITD detection improves the encoding quality and stability of the reconstructed audio of stereo signals of coincident configurations, e.g. from an MS configuration.

The configuration detection may be based on the GCC-PHAT spectrum, which is already computed to estimate the time lag, giving only a very small computational overhead compared to the baseline system.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating a stereo encoder and decoder system;

FIG. 2 is an illustration of a signal pair with inter-channel time difference, their cross-correlation and generalized cross-correlation with phase transform analysis;

FIG. 3 is an illustration of microphone configurations and their capture patterns;

FIG. 4 is an illustration of an anti-symmetric form which may occur for CC signals;

FIG. 5 is an illustration of an exemplary mask to emphasize the ITDs near zero according to some embodiments of inventive concepts;

FIG. 6 is a flow chart illustrating operations to identify CC signals and adapt the ITD search according to some embodiments of inventive concepts;

FIG. 7 is a block diagram illustrating operations of an encoder\decoder apparatus to identify CC signals and adapt the ITD search according to some embodiments of inventive concepts;

FIG. 8 is a flow chart illustrating operations to identify MS configuration signals and adapt the ITD search according to some embodiments of inventive concepts;

FIG. 9 is a block diagram illustrating operations of an encoder\decoder apparatus to identify MS configuration signals and adapt the ITD search according to some embodiments of inventive concepts;

FIG. 10 is a block diagram illustrating an exemplary environment in which an encoder and/or a decoder may operate according to some embodiments of inventive concepts;

FIG. 11 is a block diagram of a virtualization environment in accordance with some embodiments;

FIG. 12 is a block diagram illustrating an encoder according to some embodiments of inventive concepts;

FIG. 13 is a block diagram illustrating a decoder according to some embodiments of inventive concepts; and

FIGS. 14-15 are flow charts illustrating operations of an encoder or a decoder according to some embodiments of inventive concepts.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

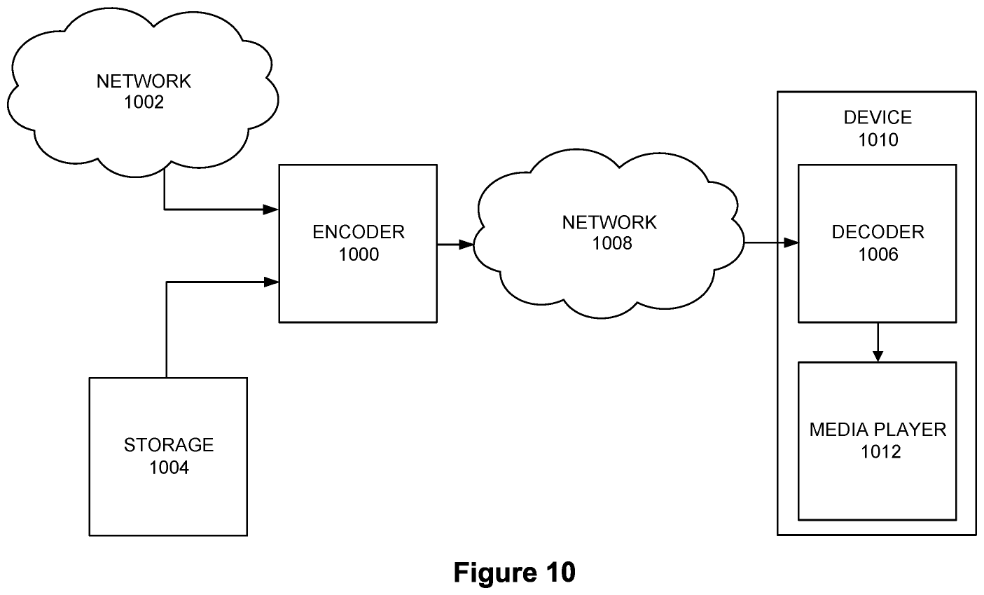

Prior to describing the embodiments in further detail, FIG. 10 illustrates an example of an operating environment of an encoder 110 that may be used to encode bitstreams as described herein. The encoder 110 receives audio from network 1002 and/or from storage 1004 and encodes the audio into bitstreams as described below and transmits the encoded audio to decoder 120 via network 1008. Storage device 1004 may be part of a storage depository of multi-channel audio signals such as a storage repository of a store or a streaming audio service, a separate storage component, a component of a mobile device, etc. The decoder 120 may be part of a device 1010 having a media player 1012. The device 1010 may be a mobile device, a set-top device, a desktop computer, and the like.

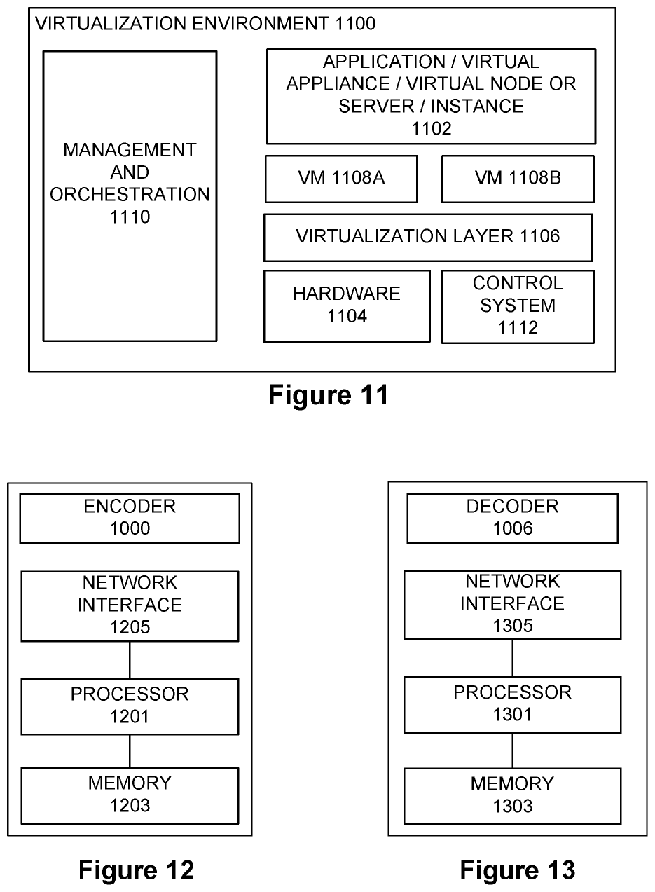

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108A and 1108B (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

FIG. 12 is a block diagram illustrating elements of encoder 1000 configured to encode audio frames according to some embodiments of inventive concepts. As shown, encoder 1000 may include a network interface circuitry 1205 (also referred to as a network interface) configured to provide communications with other devices/entities/functions/etc. The encoder 1000 may also include processor circuitry 1201 (also referred to as a processor) coupled to the network interface circuitry 1205, and a memory circuitry 1203 (also referred to as memory) coupled to the processor circuit. The memory circuitry 1203 may include computer readable program code that when executed by the processor circuitry 1201 causes the processor circuit to perform operations according to embodiments disclosed herein.

According to other embodiments, processor circuitry 1201 may be defined to include memory so that a separate memory circuit is not required. As discussed herein, operations of the encoder 1000 may be performed by processor 1201 and/or network interface 1205. For example, processor 1201 may control network interface 1205 to transmit communications to decoder 1006 and/or to receive communications through network interface 1205 from one or more other network nodes/entities/servers such as other encoder nodes, depository servers, etc. Moreover, modules may be stored in memory 1203, and these modules may provide instructions so that when instructions of a module are executed by processor 1201, processor 1201 performs respective operations.

FIG. 13 is a block diagram illustrating elements of decoder 1006 configured to decode audio frames according to some embodiments of inventive concepts. As shown, decoder 1006 may include a network interface circuitry 1305 (also referred to as a network interface) configured to provide communications with other devices/entities/functions/etc. The decoder 1006 may also include a processor circuitry 1301 (also referred to as a processor) coupled to the network interface circuit 1305, and a memory circuitry 1303 (also referred to as memory) coupled to the processor circuit. The memory circuitry 1303 may include computer readable program code that when executed by the processor circuitry 1301 causes the processing circuitry to perform operations according to embodiments disclosed herein.

According to other embodiments, processor circuitry 1301 may be defined to include memory so that a separate memory circuit is not required. As discussed herein, operations of the decoder 1006 may be performed by processor 1301 and/or network interface 1305. For example, processor circuitry 1301 may control network interface circuitry 1305 to receive communications from encoder 1000. Moreover, modules may be stored in memory 1303, and these modules may provide instructions so that when instructions of a module are executed by processor circuitry 1301, processor circuitry 1301 performs respective operations.

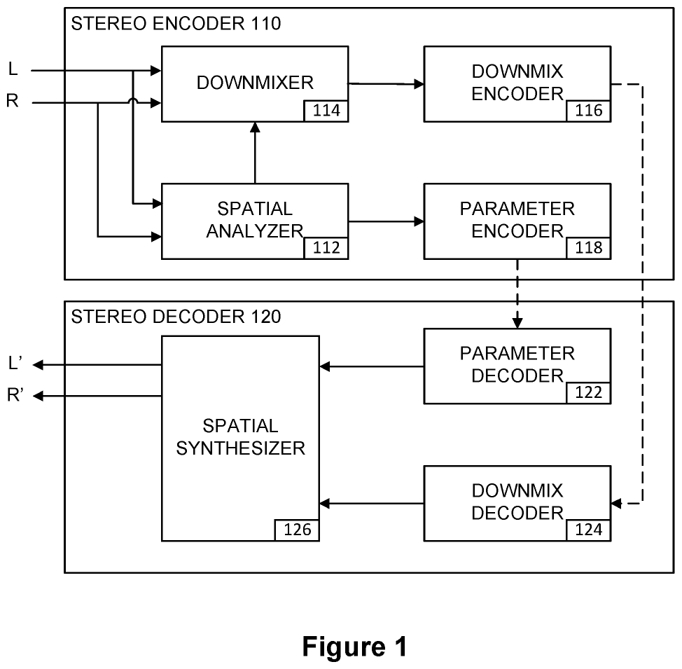

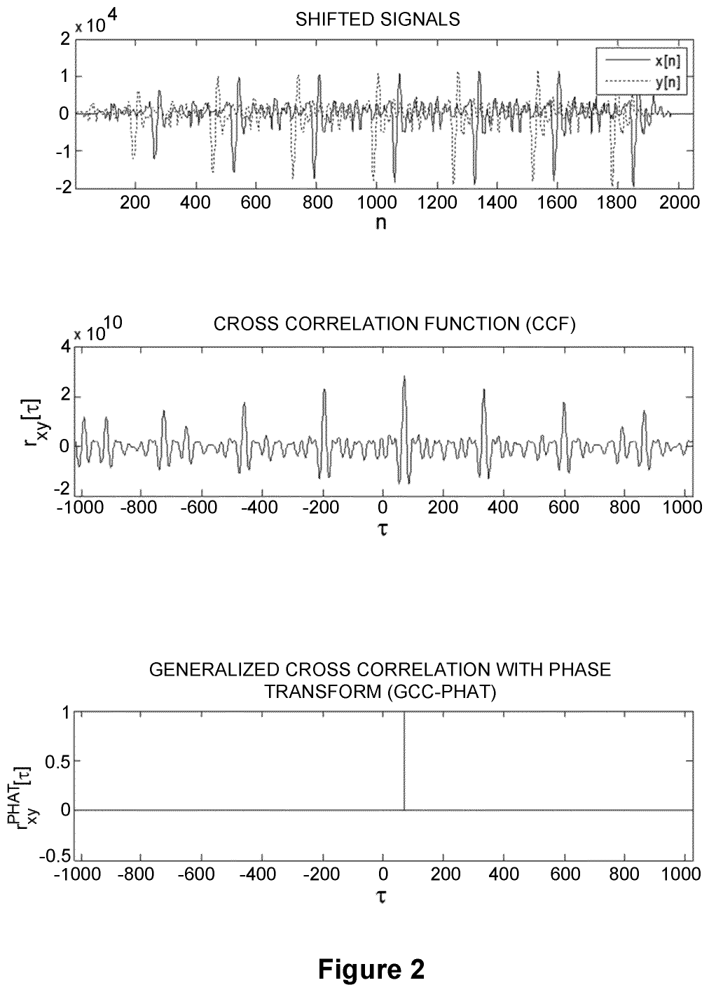

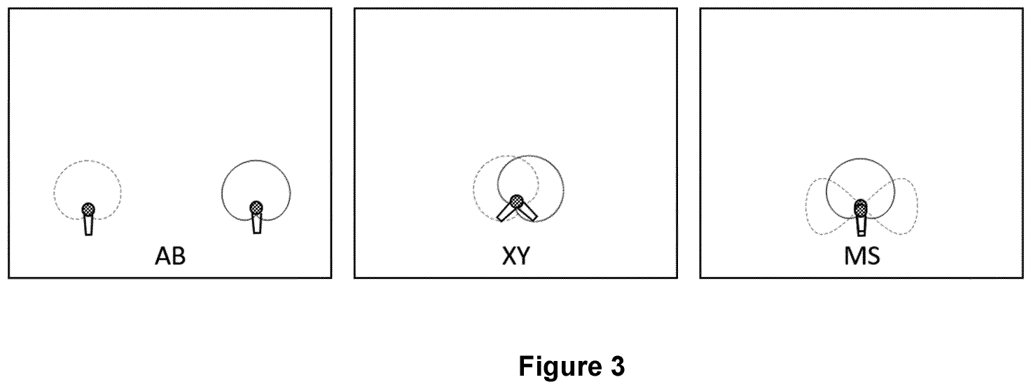

Consider a system designated to obtain spatial representation parameters for an audio input consisting of two or more audio channels. The system may be part of a stereo encoding and decoding system as outlined in FIG. 1 or the encoder/decoder. The audio input is segmented into time frames m. For a multichannel approach, the spatial parameters are typically obtained for channel pairs, and for a stereo setup this pair is simply the left and right channel, L and R. In an encoder, the method may be part of the spatial analysis to aid the downmix procedure and to encode spatial parameters to represent the spatial image. In a decoder, the method may complement a downmix procedure in case the number of received channels are larger than can be handled by the decoder unit, e.g. a stereo decoder with mono audio playback capability. Hereafter we focus on the inter-channel time difference (ITD) parameter as part of a set of spatial parameters derived by a spatial analyzer 112 for a single channel pair l(n, m) and r(n, m), where n denotes sample number and m denotes frame number. Hereafter, the index m is used to indicate a value computed for frame m.

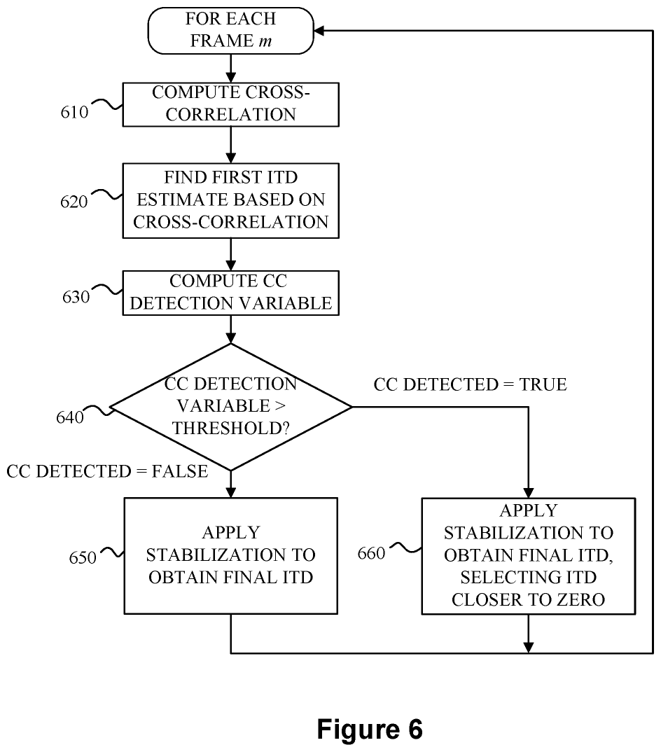

Turning to FIG. 6, the system has a designated method that is activated for stereo signals coming from a coincident configuration. The spatial representation parameters include an ITD parameter, which may be derived using a Generalized Cross-Correlation with Phase Transform (GCC-PHAT) analysis of the input channels in block 610 in some embodiments. The analysis may include a smoothing of the cross-correlation between time frames, as suggested in US20200194013A1. A first estimate of the ITD₀(m) parameter for frame m in these embodiments is the absolute maximum of the GCC-PHAT in block 620. The first estimate can be determined in accordance with

$$IT {D}_{0} ( m ) = arg {max}_{τ} ( \vert {r}_{xy}^{PHAT} ( τ ) \vert )$$

where ITD₀(m) is the first estimate of the ITD, τ is the time-lag parameter, and r_{xy}^{PHAT}(τ) is the GCC-PHAT.

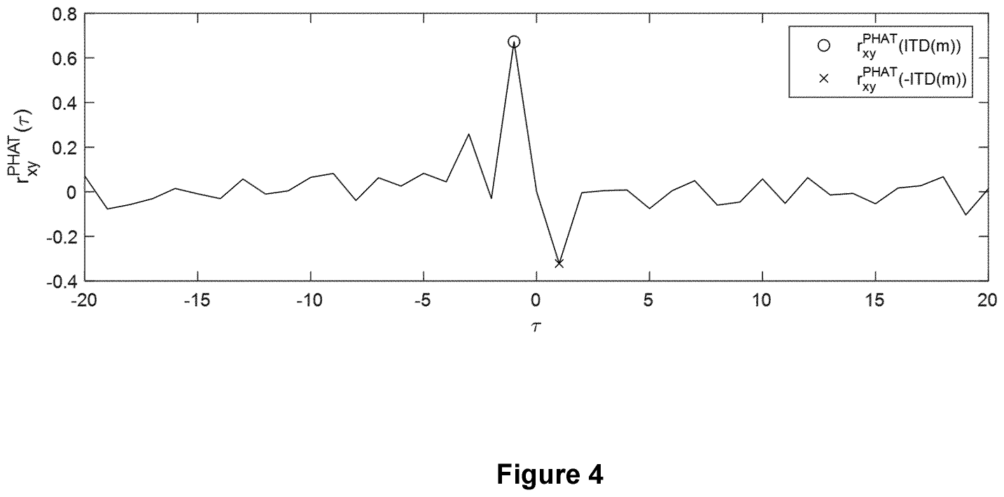

It has been observed that the GCC-PHAT of an MS signal (i.e. a certain kind of CC) may show an anti-symmetric pattern, as illustrated in FIG. 4. This structure comes from time differences due to the small distance between the microphones in the MS setup, and the fact that the S signal is added to left and right channels with opposite sign. The pattern may be exploited when forming a coincident configuration detection variable D(m) for frame m, in computing a CC detection variable in block 630.

$$D ( m ) = - {r}_{xy}^{PHAT} ( IT {D}_{0} ( m ) ) \cdot {r}_{xy}^{PHAT} ( - IT {D}_{0} ( m ) )$$

Alternative detection variables, found to give a positive indication of coincident configurations for several stereo representations, are

$$D ( m ) = max ( 0 , {\sum }_{τ = 0}^{R} \vert {r}_{xy}^{PHAT} ( τ ) {r}_{xy}^{PHAT} ( - τ ) \vert ) ,$$

$$D ( m ) = max ( 0 , \frac{1}{R + 1} {\sum }_{τ = 0}^{R} \vert {r}_{xy}^{PHAT} ( τ ) {r}_{xy}^{PHAT} ( - τ ) \vert ) ,$$

$$D ( m ) = max ( 0 , {max}_{τ = [ 0 , … , R ]} ( \vert {r}_{xy}^{PHAT} ( τ ) {r}_{xy}^{PHAT} ( - τ ) \vert ) ) ,$$

$$D ( m ) = \frac{{\sum }_{τ = 1}^{R} {r}_{xy}^{PHAT} ( τ ) {r}_{xy}^{PHAT} ( - τ )}{\sqrt{{\sum }_{τ = 1}^{R} {( {r}_{xy}^{PHAT} ( τ ) )}^{2} {\sum }_{τ = 1}^{R} {( {r}_{xy}^{PHAT} ( - τ ) )}^{2}}} ,$$

$$D ( m ) = \frac{{\sum }_{τ = - W}^{W} {r}_{xy}^{PHAT} ( IT {D}_{0} ( m ) + τ ) {r}_{xy}^{PHAT} ( - IT {D}_{0} ( m ) + τ )}{{\sum }_{τ = - W}^{W} {( {r}_{xy}^{PHAT} ( IT {D}_{0} ( m ) + τ ) )}^{2}} , or$$

$$D ( m ) = \frac{- {r}_{xy}^{PHAT} ( IT {D}_{0}^{′} ( m ) ) \cdot {r}_{xy}^{PHAT} ( - IT {D}_{0}^{′} ( m ) )}{{{r}_{xy}^{PHAT} ( IT {D}_{0} ( m ) )}^{2}}$$

where R is a search range, W defines a region around the first estimate of the ITD being matched at the time lag of the symmetry −ITD₀(m), and ITD₀′(m) is an ITD candidate limited to the search range [−R, R], e.g. determined as

$$IT {D}_{0}^{′} ( m ) = arg {max}_{τ = [ - R , R ]} ( \vert {r}_{xy}^{PHAT} ( τ ) \vert ) .$$

For coincident configurations such as MS signals, the symmetry will appear close to τ=0, and a suitable search range may be R=10 or in the range RE[5,20]. A suitable value defining the matching region is W=1 or in the range [0,5]. The herein described embodiments assume 32 kHz sampling of the audio signals, and the suitable range for parameters may depend on the sampling frequency.

To stabilize the detector, it may be desirable to low-pass filter the decision variable,

$${D}_{L P} ( m ) = α D ( m ) + ( 1 - α ) {D}_{L P} ( m - 1 )$$

where α is a low-pass filter coefficient. A suitable value for α may be α=0.1 or in the range α∈(0,0.2]. If the absolute value is not included in forming D (m), the low-pass filtering may include an absolute value.

$${D}_{L P} ( m ) = α \vert D ( m ) \vert + ( 1 - α ) {D}_{L P} ( m - 1 )$$

Since the detector variable will only give valid values when a source is active, it is beneficial to restrict the update of the decision variable to this situation. The low-pass filtered decision variable expression then becomes

$${D}_{LP} ( m ) = \{ \begin{matrix}α D ( m ) + ( 1 - α ) {D}_{LP} ( m - 1 ) , & A ( m ) = TRUE \\ {D}_{LP} ( m - 1 ) , & A ( m ) = FALSE\end{matrix}$$

where A(m) is TRUE if frame m is active, i.e. classified as containing an active source signal such as speech, and FALSE otherwise. A(m) can e.g. be the output of a voice activity detector (VAD), or the absolute maximum value of the GCC-PHAT compared to a threshold,

$$A ( m ) = \vert {r}_{xy}^{PHAT} ( IT {D}_{0} ( m ) ) \vert > {C}_{thr}$$

indicating a source is active. Here, Cₜₕᵣ is a constant where a suitable value may be Cₜₕᵣ=0.5 or in the range Cₜₕᵣ∈[0.3,0.9]. Another way to realize this behavior is to adapt the low-pass filter coefficient α using the activity indicator A(m):

$${D}_{L P} ( m ) = α ( m ) D ( m ) + ( 1 - α ( m ) ) {D}_{L P} ( m - 1 )$$

$$α ( m ) = \{ \begin{matrix}{α}_{high} , & A ( m ) = TRUE \\ {α}_{low} , & A ( m ) = FALSE\end{matrix}$$

where suitable values for the filter coefficients may be α_{high}=0.1 or in the range α∈[α_{low}, 0.5] and α_{low}=0.01 or in the range α_{low}∈[0, α_{high}]. If the activity indicator is false A(m)=FALSE the detector variable may be unreliable and it may be desirable to let the detector variable decay towards a predefined value

$${D}_{LP} ( m ) = \{ \begin{matrix}{α}_{high} D ( m ) + ( 1 - {α}_{high} ) {D}_{LP} ( m - 1 ) , & A ( m ) = TRUE \\ {α}_{low} {D}_{0} + ( 1 - {α}_{low} ) {D}_{LP} ( m - 1 ) , & A ( m ) = FALSE\end{matrix}$$

where D₀ is a predefined value such as D₀=0 or D₀=D_{THR} where D_{THR} is a decision threshold described below.

To decide whether the signal is a CC signal, the detector variable can be compared to a threshold in block 640.

$$CC detected = \{ \begin{matrix}TRUE , & {D}_{LP} ( m ) \geq {D}_{THR} \\ FALSE , & {D}_{LP} ( m ) < {D}_{THR}\end{matrix}$$

If the absolute value is not included in forming D(m) and consequently D_{LP}(m), the comparison to the threshold may include an absolute value.

$$CC detected = \{ \begin{matrix}TRUE , & \vert {D}_{LP} ( m ) \vert \geq {D}_{THR} \\ FALSE , & \vert {D}_{LP} ( m ) \vert < {D}_{THR}\end{matrix}$$

Note that indicating the signal is a CC signal means the signal is coming from a coincident microphone configuration. If a CC signal has been detected, the ITD search may be influenced such that ITDs close to zero are favored. Stabilization of the ITD is applied e.g. as described in U.S. Application Publication No. US20200194013A1, resulting in a stabilized ITD ITD_{stab}(m) in block 650. If a CC signal is detected, the ITD with the smallest absolute value is selected in block 660 in some embodiments of inventive concepts.

$$IT {D}_{1} ( m ) = \{ \begin{matrix}IT {D}_{stab} ( m ) , & CC detected = TRUE , \vert IT {D}_{stab} ( m ) \vert < \vert IT {D}_{0} ( m ) \vert \\ IT {D}_{0} ( m ) , & CC detected = TRUE , \vert IT {D}_{stab} ( m ) \vert \geq \vert IT {D}_{0} ( m ) \vert \\ IT {D}_{stab} ( m ) , & CC detected = FALSE\end{matrix}$$

where ITD₁(m) is the final ITD, ITD₀(m) is the first ITD estimate, and ITD_{stab}(m) is a stabilized ITD. It should be noted that the stabilization procedure may result in a stabilized ITD which is the same as the first ITD estimate, which means ITD₁(m) may be the same as ITD₀(m) even if a CC signal is not detected, CC detected=FALSE. In another embodiment, the switch to a smaller absolute value is only done if the absolute value is within a range [−R₁, R₁] from zero.

$$IT {D}_{1} ( m ) = \{ \begin{matrix}IT {D}_{stab} ( m ) , & CC detected = TRUE , \vert IT {D}_{stab} ( m ) \vert < \vert IT {D}_{0} ( m ) \vert \\ IT {D}_{0} ( m ) , & \begin{matrix}CC detected = TRUE , \vert IT {D}_{stab} ( m ) \vert \geq \\ \vert IT {D}_{0} ( m ) \vert , \vert IT {D}_{0} ( m ) \vert \leq {R}_{1}\end{matrix} \\ IT {D}_{stab} ( m ) , & CC detected = TRUE , \vert IT {D}_{stab} ( m ) \vert \geq \vert IT {D}_{0} ( m ) \vert > {R}_{1} \\ IT {D}_{stab} ( m ) , & CC detected = FALSE\end{matrix}$$

For a sampling frequency of 32 kHz, a suitable value for R₁ is R₁=10 or in the range R₁∈[5,20].

Further stabilization may be applied, e.g. considering previous ITD values as in U.S. Application Publication No. US20200211575A1. Again, if a CC signal has been detected, the result of the stabilization is accepted if the absolute value is closer to zero in block 660. Again, the decision to keep a previously obtained ITD instead of a stabilized ITD could also depend on if the previously obtained ITD is within a range from zero, e.g. [−R₁, R₁].

Another way to favor ITDs closed to zero is to apply a weighting of the GCC-PHAT r_{xy}^{PHAT} (τ) to complement the stabilization 660 by giving larger weight to values close to zero. A weighting w(τ) may be obtained by

$$w ( τ ) = max ( 0 , 1 - \vert τ ( 1 + C ) / IT {D}_{MAX} \vert )$$

If, on the other hand, a CC signal is not detected, the weighting is omitted, which is equivalent of setting the weighting to 1.

$$w ( τ ) = \{ \begin{matrix}max ( 0 , 1 - \vert τ ( 1 + C ) / IT {D}_{MAX} \vert ) , & CC detected = TRUE \\ 1 , & CC detected = FALSE\end{matrix}$$

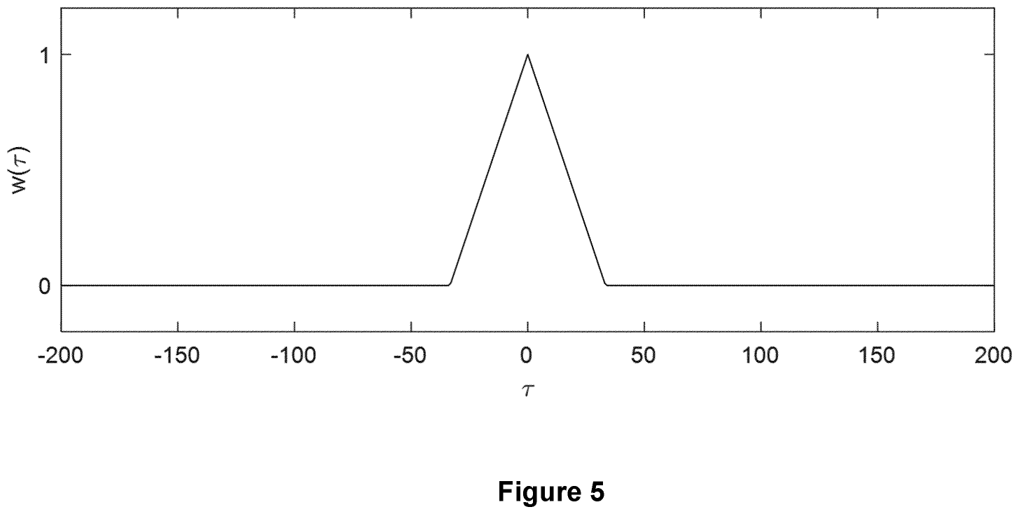

This weighting function effectively masks out a wedge of correlation values around zero, as illustrated in FIG. 5 for C=5 and ITD_{MAX}=200, which may be suitable values for these constants for a sampling frequency of 32 kHz. The ITD estimate is then the absolute maximum of the weighted GCC-PHAT

$$IT {D}_{w} ( m ) = arg {max}_{τ} ( \vert {r}_{xy}^{PHAT} ( τ ) w ( τ ) \vert )$$

Note that in case where CC detected=FALSE, the already obtained ITD₀(m) may be used.

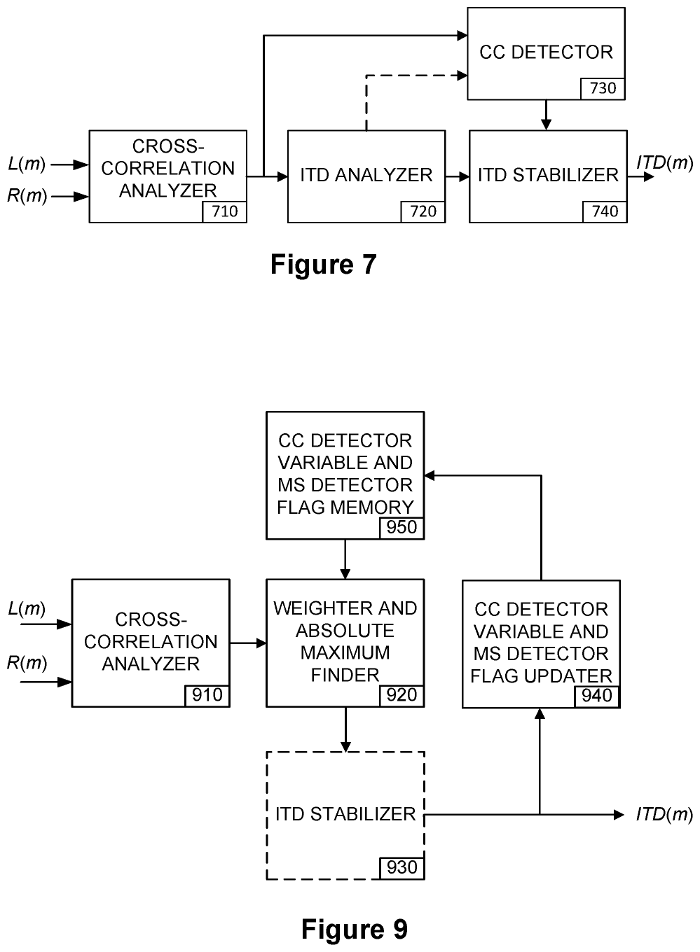

Turning to FIG. 7, the embodiments described above may be implemented by a cross-correlation analyzer 710 which may produce a GCC-PHAT analysis of the input signals L and R. A first ITD estimate is generated by the ITD analyzer 720. A CC detector 730 detects low-ITD signals such as CC signals using at least the output of the cross-correlation analyzer and optionally the first ITD estimate. The CC detector forms a CC detector variable which is compared to a threshold to determine if a CC signal is present. If a CC signal is detected, it directs the ITD stabilizer 740 to favor ITD values close to zero.

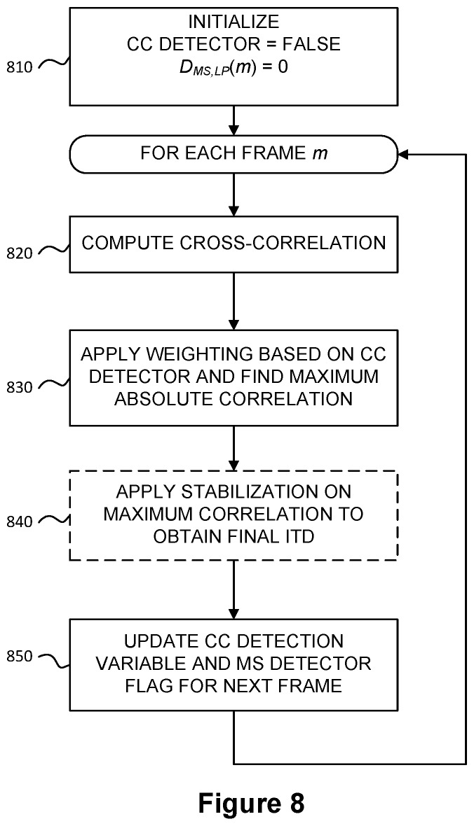

FIG. 8 illustrates an embodiment where the CC detection is based on the analysis of the previous frame. During the startup of the system, an MS detector variable memory and MS detector flag is initialized in block 810. For each frame m, blocks 820 to 850 are performed.

In block 820, a cross-correlation r_{xy}^{PHAT} is computed. An absolute maximum ITD₁(m) of the weighted cross-correlation is determined in block 830 in accordance with

$$IT {D}_{1} ( m ) = arg {max}_{τ} ( \vert {r}_{xy}^{PHAT} ( τ ) w ( τ ) \vert )$$

The weighting can be the same as in block 640 described above, but the decision is based on the CC detection from the previous frame.

$$w ( τ ) = \{ \begin{matrix}max ( 0 , 1 - \vert τ ( 1 + C ) / IT {D}_{MAX} \vert ) , & CC detected ( m - 1 ) = TRUE \\ 1 , & CC detected ( m - 1 ) = FALSE\end{matrix}$$

The identified maximum may be further stabilized in an optional block 840, similar to the stabilization done in block 660 as described above. A CC detection variable is derived in block 850 similar to the derivation described above in block 630. The value is then stored to be used in the following frame.

$$CC detected ( m ) = \{ \begin{matrix}TRUE , & {D}_{LP} ( m ) \geq {D}_{THR} \\ FALSE , & {D}_{LP} ( m ) < {D}_{THR}\end{matrix}$$

If the absolute value is not included in forming D(m) and consequently D_{LP}(m), the comparison to the threshold may include an absolute value.

$$CC detected ( m ) = \{ \begin{matrix}TRUE , & \vert {D}_{LP} ( m ) \vert \geq {D}_{THR} \\ FALSE , & \vert {D}_{LP} ( m ) \vert < {D}_{THR}\end{matrix}$$

In this case the decision variable may be formed using instantaneous estimate ITD₀(m) or the final ITD value ITD(m) including potential stabilization methods in block 840.

Turning to FIG. 9, the embodiments described in FIG. 8 may be implemented by a cross-correlation analyzer 910 which may produce a GCC-PHAT analysis of the input signals L and R. The weighter and absolute maximum finder 920 weights the cross-correlation and determines the absolute maximum ITD of the weighted cross-correlation. Optional ITD stabilizer 930 stabilizes the identified maximum ITD to obtain the final ITD₁(m). MS detector variable and CC detector flag updater 940 derives the CC detection variable and provides the CC detection variable to the CC detector variable and CC detector flag memory 950 for storing the CC detector variable for use in the following frame.

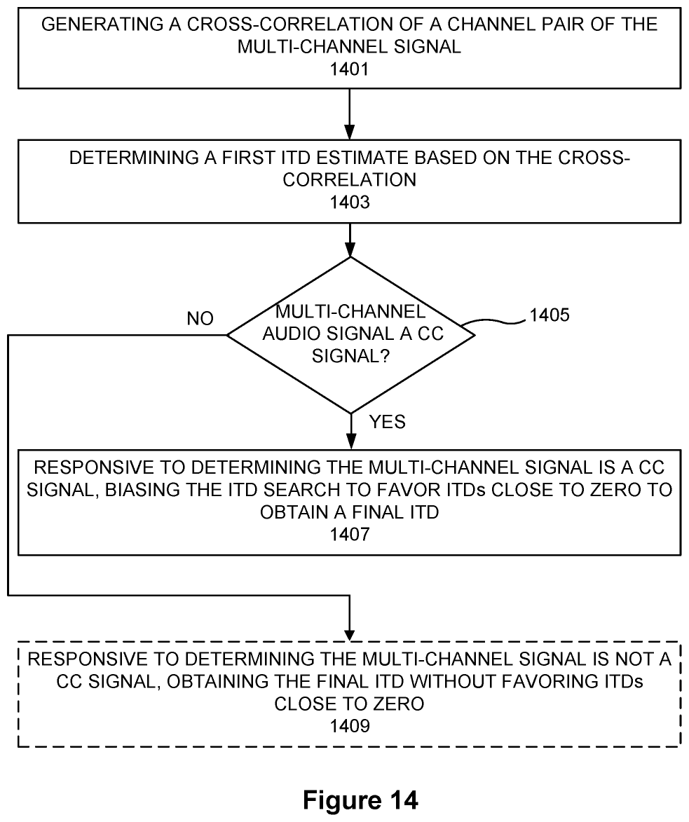

In the description that follows, while the encoder may be any of the stereo encoder 110, encoder 1000, virtualization hardware 1104, or virtual machines 1108A, 1108B, the encoder 1000 shall be used to describe the functionality of the operations of the encoder. Similarly, while the decoder may be any of the stereo decoder 120, decoder 1006, hardware 1104, or virtual machine 1108A, 1108B, the decoder 1006 shall be used to describe the functionality of the operations of the decoder. Operations of the encoder 1000 (implemented using the structure of the block diagram of FIG. 12) or decoder 1006 (implemented using the structure of the block diagram of FIG. 13) will now be discussed with reference to the flow chart of FIG. 14 according to some embodiments of inventive concepts. For example, modules may be stored in memory 1203 of FIG. 12 or memory 1303 of FIG. 13, and these modules may provide instructions so that when the instructions of a module are executed by respective processing circuitry 1201/1301, processing circuitry 1201/1301 performs respective operations of the flow chart.

FIG. 14 illustrates a method to identify coincident microphone configurations, CC, and adapt an inter-channel time difference, ITD, search, in an encoder or a decoder. For the decoder, the time that the method is primarily used is when the decoder receives a stereo signal but the audio device only has mono playback capability.

Turning to FIG. 14, the operations in block 1401 to 1409 are performed for each frame m of a multi-channel audio signal. In block 1401, the processing circuitry 1201/1301 generates a cross-correlation of a channel pair of the multi-channel audio signal. The cross-correlation generation may be generated as described above in FIGS. 6 and 8. In some embodiments of the inventive concepts, the cross-correlation is a generalized cross-correlation with phase transform (GCC-PHAT).

In block 1403, the processing circuitry 1201/1301 determines a first ITD estimate based on the cross-correlation. The processing circuitry 1201/1301 may determine the first ITD estimate by determining the first ITD estimate as an absolute maximum of the cross-correlation. In some embodiments, the processing circuitry 1201/1301 determines the absolute maximum of the cross-correlation in accordance with

$$IT {D}_{0} ( m ) = arg {max}_{τ} ( \vert {r}_{xy}^{PHAT} ( τ ) \vert )$$

where ITD₀(m) is the first ITD estimate, r_{xy}^{PHAT}(τ) is the cross-correlation, and τ is a time-lag parameter.

In block 1405, the processing circuitry 1201/1301 determines if the multi-channel audio signal is a CC signal.

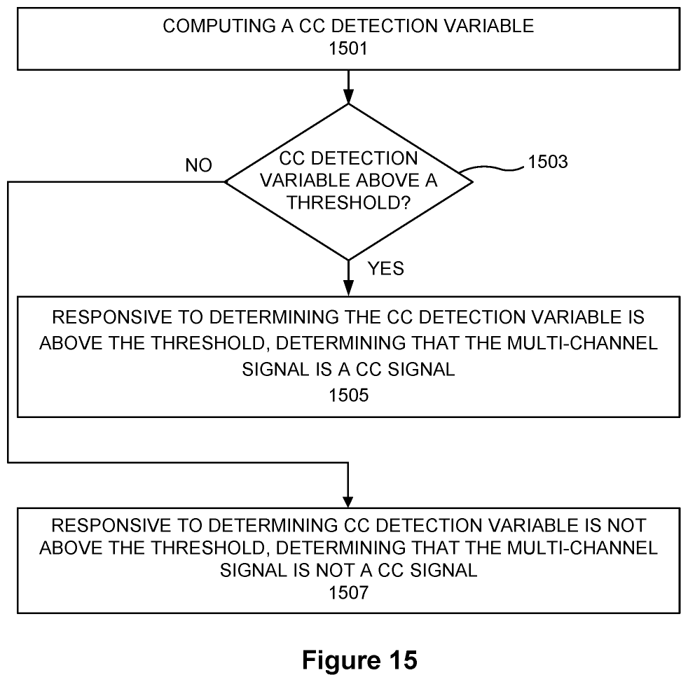

In some embodiments, of inventive concepts, the processing circuitry 1201/1301 determines if the multi-channel audio signal is a CC signal based on a CC detection variable. FIG. 15 illustrates an embodiment of determining if the multi-channel audio signal is a CC signal based on a CC detection variable. Turning to FIG. 15, in block 1501, the processing circuitry 1201/1301 computes a CC detection variable. Computing the CC detection variable is described above.

In block 1503, the processing circuitry 1201/1301 determines if the CC detection variable is above a threshold. In some of these embodiments, the processing circuitry 1201/1301 determines if the CC detection variable is above a threshold by determining if an absolute value of the CC detection variable is above the threshold value.

In block 1505, the processing circuitry 1201/1301, responsive to determining the CC detection variable is above the threshold, determines that the multi-channel audio signal is a CC signal. In block 1507, the processing circuitry 1201/1301, responsive to determining the CC detection variable is not above the threshold, determines that the multi-channel audio signal is not a CC signal.

In other embodiments, the processing circuitry 1201/1301 determines if the multi-channel audio signal is a CC signal by detecting one of an anti-symmetric pattern and a symmetric pattern in the cross-correlation in the channel pair of the multi-channel audio signal. In some embodiments, detecting the anti-symmetric pattern in the component comprises detecting the anti-symmetric pattern in accordance with

$$D ( m ) = - {r}_{xy}^{PHAT} ( IT {D}_{0} ( m ) ) \cdot {r}_{xy}^{PHAT} ( - IT {D}_{0} ( m ) )$$

where D(m) is a CC detection variable, r_{xy}^{PHAT} is the GCC-PHAT, and ITD₀(m) is the first ITD estimate.

In other embodiments of inventive concepts, the processing circuitry 1201/1301 detects the one of an anti-symmetric pattern and a symmetric pattern in the cross-correlation by detecting the anti-symmetric pattern in accordance with at least one of

$$D ( m ) = max ( 0 , {\sum }_{τ = 0}^{R} \vert {r}_{xy}^{PHAT} ( τ ) {r}_{xy}^{PHAT} ( - τ ) \vert ) ,$$

$$D ( m ) = max ( 0 , \frac{1}{R + 1} {\sum }_{τ = 0}^{R} \vert {r}_{xy}^{PHAT} ( τ ) {r}_{xy}^{PHAT} ( - τ ) \vert ) ,$$

$$D ( m ) = max ( 0 , {max}_{τ = [ 0 , … , R ]} ( \vert {r}_{x y}^{P H A T} ( τ ) {r}_{xy}^{PHAT} ( - τ ) \vert ) )$$

$$D ( m ) = \frac{{\sum }_{τ = 1}^{R} {r}_{xy}^{PHAT} ( τ ) {r}_{xy}^{PHAT} ( - τ )}{\sqrt{{\sum }_{τ = 1}^{R} {( {r}_{xy}^{PHAT} ( τ ) )}^{2} {\sum }_{τ = 1}^{R} {( {r}_{xy}^{PHAT} ( - τ ) )}^{2}}}$$

$$D ( m ) = \frac{{\sum }_{τ = - W}^{W} {r}_{xy}^{PHAT} ( IT {D}_{0} ( m ) + τ ) {r}_{xy}^{PHAT} ( - IT {D}_{0} ( m ) + τ )}{{\sum }_{τ = - W}^{W} {( {r}_{x y}^{P H A T} ( IT {D}_{0} ( m ) + τ ) )}^{2}} , or$$

$$D ( m ) = \frac{- {r}_{xy}^{PHAT} ( IT {D}_{0}^{′} ( m ) ) \cdot {r}_{xy}^{PHAT} ( - IT {D}_{0}^{′} ( m ) )}{{{r}_{xy}^{PHAT} ( IT {D}_{0} ( m ) )}^{2}} ,$$

where D(m) is a CC detection variable, r_{xy}^{PHAT} is the GCC-PHAT, R is a search range, W defines a region around the first estimate of the ITD being matched, and ITD₀′(m) is an ITD candidate limited to the search range [−R, R].

Returning to FIG. 14, in block 1407, the processing circuitry 1201/1301 responsive to determining that the multi-channel audio signal is a CC signal, biases the ITD search to favor ITDs close to zero to obtain a final ITD.

In some embodiments, the processing circuitry 1201/1301 biases the ITD search to favor ITDs close to zero to obtain the final ITD by selecting an ITD having a smallest absolute value. In these embodiments, the processing circuitry 1201/1301 selects the ITD having the smallest absolute value comprises selecting the ITD as the final ITD in accordance with

$$IT {D}_{1} ( m ) = \{ \begin{matrix}IT {D}_{stab} ( m ) , & CC detected , \vert IT {D}_{stab} ( m ) \vert < \vert IT {D}_{0} ( m ) \vert \\ IT {D}_{0} ( m ) , & CC detected , \vert IT {D}_{stab} ( m ) \vert \geq \vert IT {D}_{0} ( m ) \vert\end{matrix}$$

where ITD₁(m) is the final ITD, ITD₀(m) is the first ITD estimate, and ITD_{stab}(m) is a stabilized ITD.

In other embodiments of inventive concepts, the processing circuitry 1201/1301 biases the ITD search to favor ITDs close to zero by selecting the final ITD from the ITD candidates within a limited range around zero.

In further embodiments of inventive concepts, the processing circuitry 1201/1301 biases the ITD search to favor ITDs close to zero by applying a weighting of a cross-correlation to assign larger weight to values of the cross-correlation close to zero.

Returning to FIG. 14, in block 1409, the processing circuitry 1201/1301, responsive to determining that the multi-channel audio signal is not a CC signal, obtains the final ITD without favoring ITDs close to zero.

In some other embodiments of inventive concepts, the processing circuitry 1201/1301 applies stabilization to an ITD candidate selected to obtain the final ITD. The ITD candidate selected is selected from at least one ITD candidate generated.

Various operations from the flow chart of FIG. 14 may be optional with respect to some embodiments of encoder/decoders and related methods. Regarding methods of example embodiment 1 (set forth below), for example, operations of block 1409 of FIG. 14 may be optional.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments are discussed below.

Embodiment 1. A method to identify coincident microphone configurations, CC, and adapt an inter-channel time difference, ITD, search, in an encoder (110, 1000) or a decoder (120, 1006), the method comprising:
for each frame m of a multi-channel audio signal:
   generating (1401) a cross-correlation of a channel pair of the multi-channel audio signal;
   determining (1403) a first ITD estimate based on the cross-correlation;
   determining (1405) if the multi-channel audio signal is a CC signal; and
   responsive to determining that the multi-channel audio signal is a CC signal, biasing (1407) the ITD search to favor ITDs close to zero to obtain a final ITD.
      Embodiment 2. The method of Embodiment 1, further comprising responsive to determining that the multi-channel audio signal is not a CC signal, obtaining (1409) the final ITD without favoring ITDs close to zero.
      Embodiment 3. The method of Embodiment 2 wherein obtaining the final ITD when the multi-channel audio signal is not a CC signal comprises obtaining the final ITD by setting the final ITD to the first ITD estimate.
      Embodiment 4. The method of any of Embodiments 1-2, further comprising applying stabilization to an ITD candidate selected to obtain the final ITD.
      Embodiment 5. The method of Embodiment 4, wherein applying stabilization further comprises generating at least one ITD candidate.
      Embodiment 6. The method of any of Embodiment 1-5, wherein biasing the ITD search to favor ITDs close to zero to obtain the final ITD comprises obtaining the final ITD by selecting an ITD having a smallest absolute value.
      Embodiment 7. The method of Embodiment 6 wherein selecting the ITD having the smallest absolute value comprises selecting the ITD as the final ITD in accordance with

$${ITD}_{1} ( m ) = \{ \begin{matrix}{ITD}_{stab} ( m ) , & CC detected , \vert {ITD}_{stab} ( m ) \vert < \vert {ITD}_{0} ( m ) \vert \\ {ITD}_{0} ( m ) , & CC detected , \vert {ITD}_{stab} ( m ) \vert \geq \vert {ITD}_{0} ( m ) \vert\end{matrix}$$

where ITD₁(m) is the final ITD, ITD₀(m) is the first ITD estimate, and ITD_{stab}(m) is a stabilized ITD.
Embodiment 8. The method of any of Embodiments 1-7, wherein biasing the ITD search to favor ITDs close to zero comprises selecting the final ITD from ITD candidates within a limited range around zero.
Embodiment 9. The method of any of Embodiments 1-3, wherein biasing the ITD search to favor ITDs close to zero to obtain the final ITD comprises applying a weighting of a cross-correlation to assign larger weight to values of the cross-correlation close to zero.
Embodiment 10. The method of any of Embodiment 1-9, wherein determining the first ITD estimate comprises determining the first ITD estimate as an absolute maximum of the cross-correlation.
Embodiment 11. The method of Embodiment 10, wherein determining the first ITD estimate as the absolute maximum of the cross-correlation comprises determining the absolute maximum in accordance with

$${ITD}_{0} ( m ) = arg {max}_{τ} ( \vert {r}_{xy}^{PHAT} ( τ ) \vert )$$

where ITD₀(m) is the first ITD estimate, r_{xy}^{PHAT}(τ) is the cross-correlation, and τ is a time-lag parameter.
Embodiment 12. The method in any of the preceding Embodiments where the cross-correlation is a generalized cross-correlation with phase transform (GCC-PHAT).
Embodiment 13. The method of any of Embodiments 1-12 wherein determining if the multi-channel audio signal is a CC signal comprises:
detecting one of an anti-symmetric pattern and a symmetric pattern in the cross-correlation in the channel pair of the multi-channel audio signal.
   Embodiment 14. The method of Embodiment 13 wherein detecting the anti-symmetric pattern in the component comprises detecting the anti-symmetric pattern in accordance with

$$D ( m ) = - {r}_{xy}^{PHAT} ( {ITD}_{0} ( m ) ) \cdot {r}_{xy}^{PHAT} ( - {ITD}_{0} ( m ) )$$

where D(m) is a CC detection variable, r_{xy}^{PHAT} is the GCC-PHAT, and ITD₀(m) is the first ITD estimate.
Embodiment 15. The method of Embodiment 13 wherein detecting the one of an anti-symmetric pattern and a symmetric pattern in the cross-correlation comprises detecting the anti-symmetric pattern in accordance with at least one of

$$D ( m ) = max ( 0 , {\sum }_{τ = 0}^{R} \vert {r}_{xy}^{PHAT} ( τ ) {r}_{xy}^{PHAT} ( - τ ) \vert ) ,$$

$$D ( m ) = max ( 0 , \frac{1}{R + 1} {\sum }_{τ = 0}^{R} \vert {r}_{xy}^{PHAT} ( τ ) {r}_{xy}^{PHAT} ( - τ ) \vert ) ,$$

$$D ( m ) = max ( 0 , {max}_{0 , τ = [ 0 , … , R ]} ( \vert {r}_{xy}^{PHAT} ( τ ) {r}_{xy}^{PHAT} ( - τ ) \vert ) )$$

$$D ( m ) = \frac{{\sum }_{τ = 1}^{R} {r}_{xy}^{PHAT} ( τ ) {r}_{xy}^{PHAT} ( - τ )}{\sqrt{{\sum }_{τ = 1}^{R} {( {r}_{xy}^{PHAT} ( τ ) )}^{2} {\sum }_{τ = 1}^{R} {( {r}_{xy}^{PHAT} ( - τ ) )}^{2}}}$$

$$D ( m ) = \frac{{\sum }_{τ = - W}^{W} {r}_{xy}^{PHAT} ( {ITD}_{0} ( m ) + τ ) {r}_{xy}^{PHAT} ( - {ITD}_{0} ( m ) + τ )}{{\sum }_{τ = - W}^{W} {( {r}_{xy}^{PHAT} ( {ITD}_{0} ( m ) + τ ) )}^{2}} , or$$

$$D ( m ) = \frac{- {r}_{xy}^{PHAT} ( {ITD}_{0}^{′} ( m ) ) \cdot {r}_{xy}^{PHAT} ( - {ITD}_{0}^{′} ( m ) )}{{{r}_{xy}^{PHAT} ( {ITD}_{0} ( m ) )}^{2}} ,$$

where D(m) is a CC detection variable, r_{xy}^{PHAT} is the GCC-PHAT, R is a search range, W defines a region around the first estimate of the ITD being matched, and ITD₀′(m) is an ITD candidate limited to the search range [−R, R].
Embodiment 16. The method of any of Embodiments 1-12 wherein determining if the multi-channel audio signal is a CC signal comprises:
computing (1501) a CC detection variable;
determining (1503) if the CC detection variable is above a threshold value; and
responding to determining the CC detection variable is above the threshold, determining (1505) that the multi-channel audio signal is a CC signal.
   Embodiment 17. The method of Embodiment 16 wherein determining if the CC detection variable is above the threshold value comprises determining if an absolute value of the CC detection variable is above the threshold value.
   Embodiment 18. The method in any of Embodiments 14-17 further comprising filtering the CC detection variable with low-pass filtering to stabilize the CC detection.
   Embodiment 19. The method of Embodiment 18 wherein the low-pass filtering on the CC detection variable is adaptive, depending on at least an output A(m) of an activity detector.
   Embodiment 20. The method of Embodiment 19 wherein filtering the CC detection variable with low-pass filtering comprises filtering with adaptive low-pass filtering in accordance with

$${D}_{LP} ( m ) = α ( m ) D ( m ) + ( 1 - α ( m ) ) {D}_{LP} ( m - 1 )$$

$$α ( m ) = \{ \begin{matrix}{α}_{high} , & A ( m ) = TRUE \\ {α}_{low} , & A ( m ) = FALSE\end{matrix}$$

where A(m) is the output of an activity detector and α_{high} and α_{low} are filter coefficients.
Embodiment 21. An apparatus (110, 120, 1000, 1006) comprising:
processing circuitry (1201, 1301); and
memory (1205, 1305) coupled with the processing circuitry, wherein the memory includes instructions that when executed by the processing circuitry causes the apparatus to:
for each frame m of a multi-channel audio signal:
   generate (1401) a cross-correlation of a channel pair of the multi-channel audio signal;
   determine (1403) a first ITD estimate based on the cross-correlation;
   determine (1405) if the multi-channel audio signal is a CC signal; and
   responsive to determining that the multi-channel audio signal is a CC signal, bias (1407) the ITD search to favor ITDs close to zero to obtain a final ITD.
      Embodiment 22. The apparatus (110, 120, 1000, 1006) of Embodiment 21, further comprising responsive to determining that the multi-channel audio signal is not a CC signal, obtaining (1409) the final ITD without favoring ITDs close to zero.
      Embodiment 23. The apparatus (110, 120, 1000, 1006) of Embodiment 22 wherein obtaining the final ITD when the multi-channel audio signal is not a CC signal comprises obtaining the final ITD by setting the final ITD to the first ITD estimate.
      Embodiment 24. The apparatus (110, 120, 1000, 1006) of any of Embodiments 21-22, wherein the memory includes further instructions that when executed by the processing circuitry causes the apparatus to apply stabilization to an ITD candidate selected to obtain the final ITD.
      Embodiment 25. The apparatus (110, 120, 1000, 1006) of Embodiment 24, wherein applying stabilization further comprises generating at least one ITD candidate.
      Embodiment 26. The apparatus (110, 120, 1000, 1006) of any of Embodiments 21-25, wherein biasing the ITD search to favor ITDs close to zero to obtain the final ITD comprises obtaining the final ITD by selecting an ITD having a smallest absolute value.
      Embodiment 27. The apparatus (110, 120, 1000, 1006) of Embodiment 26 wherein selecting the ITD having the smallest absolute value comprises selecting the ITD as the final ITD in accordance with

$${ITD}_{1} ( m ) = \{ \begin{matrix}{ITD}_{stab} ( m ) , & CC detected , \vert {ITD}_{stab} ( m ) \vert < \vert {ITD}_{0} ( m ) \vert \\ {ITD}_{0} ( m ) , & CC detected , \vert {ITD}_{stab} ( m ) \vert \geq \vert {ITD}_{0} ( m ) \vert\end{matrix}$$

where ITD₁(m) is the final ITD, ITD₀(m) is the first ITD estimate, and ITD_{stab}(m) is a stabilized ITD.
Embodiment 28. The apparatus (110, 120, 1000, 1006) of any of Embodiments 21-27, wherein biasing the ITD search to favor ITDs close to zero comprises selecting the final ITD from ITD candidates within a limited range around zero.
Embodiment 29. The apparatus (110, 120, 1000, 1006) of any of Embodiments 21-27, wherein biasing the ITD search to favor ITDs close to zero to obtain the final ITD comprises applying a weighting of a cross-correlation to assign larger weight to values of the cross-correlation close to zero.
Embodiment 30. The apparatus (110, 120, 1000, 1006) of any of Embodiments 21-29, wherein determining the first ITD estimate comprises determining the first ITD estimate as an absolute maximum of the cross-correlation.
Embodiment 31. The apparatus (110, 120, 1000, 1006) of Embodiment 30, wherein determining the first ITD estimate as the absolute maximum of the cross-correlation comprises determining the absolute maximum in accordance with

$${ITD}_{0} ( m ) = arg {max}_{τ} ( \vert {r}_{xy}^{PHAT} ( τ ) \vert )$$

where ITD₀(m) is the first ITD estimate, r_{xy}^{PHAT}(τ) is the cross-correlation, and τ is a time-lag parameter.
Embodiment 32. The apparatus (110, 120, 1000, 1006) in any of the preceding Embodiments where the cross-correlation is a generalized cross-correlation with phase transform (GCC-PHAT).
Embodiment 33. The apparatus (110, 120, 1000, 1006) of any of Embodiments 21-31 wherein determining if the multi-channel audio signal is a CC signal comprises:
detecting one of an anti-symmetric pattern and a symmetric pattern in the cross-correlation in the channel pair of the multi-channel audio signal.
   Embodiment 34. The apparatus (110, 120, 1000, 1006) of Embodiment 33 wherein detecting the anti-symmetric pattern in the component comprises detecting the anti-symmetric pattern in accordance with

$$D ( m ) = - {r}_{xy}^{PHAT} ( {ITD}_{0} ( m ) ) \cdot {r}_{xy}^{PHAT} ( - {ITD}_{0} ( m ) )$$

where D(m) is a CC detection variable, r_{xy}^{PHAT} is the GCC-PHAT, and ITD₀(m) is the first ITD estimate.+
Embodiment 35. The apparatus (110, 120, 1000, 1006) of Embodiment 35 wherein detecting the one of an anti-symmetric pattern and a symmetric pattern in the cross-correlation comprises detecting the anti-symmetric pattern in accordance with at least one of

$$D ( m ) = max ( 0 , {\sum }_{τ = 0}^{R} \vert {r}_{xy}^{PHAT} ( τ ) {r}_{xy}^{PHAT} ( - τ ) \vert ) ,$$

$$D ( m ) = max ( 0 , \frac{1}{R + 1} {\sum }_{τ = 0}^{R} \vert {r}_{xy}^{PHAT} ( τ ) {r}_{xy}^{PHAT} ( - τ ) \vert ) ,$$

$$D ( m ) = max ( 0 , {max}_{0 , τ = [ 0 , … , R ]} ( \vert {r}_{xy}^{PHAT} ( τ ) {r}_{xy}^{PHAT} ( - τ ) \vert ) ) ,$$

$$D ( m ) = \frac{{\sum }_{τ = 1}^{R} {r}_{xy}^{PHAT} ( τ ) {r}_{xy}^{PHAT} ( - τ )}{\sqrt{{\sum }_{τ = 1}^{R} {( {r}_{xy}^{PHAT} ( τ ) )}^{2} {\sum }_{τ = 1}^{R} {( {r}_{xy}^{PHAT} ( - τ ) )}^{2}}} ,$$

$$D ( m ) = \frac{{\sum }_{τ = - W}^{W} {r}_{xy}^{PHAT} ( {ITD}_{0} ( m ) + τ ) {r}_{xy}^{PHAT} ( - {ITD}_{0} ( m ) + τ )}{{\sum }_{τ = - W}^{W} {( {r}_{xy}^{PHAT} ( {ITD}_{0} ( m ) + τ ) )}^{2}} , or$$

$$D ( m ) = \frac{- {r}_{xy}^{PHAT} ( {ITD}_{0}^{′} ( m ) ) \cdot {r}_{xy}^{PHAT} ( - {ITD}_{0}^{′} ( m ) )}{{{r}_{xy}^{PHAT} ( {ITD}_{0} ( m ) )}^{2}} ,$$

where D(m) is a CC detection variable, r_{xy}^{PHAT} is the GCC-PHAT, R is a search range, W defines a region around the first estimate of the ITD being matched, and ITD₀′(m) is an ITD candidate limited to the search range [−R, R].
Embodiment 36. The apparatus (110, 120, 1000, 1006) of any of Embodiments 21-32 wherein determining if the multi-channel audio signal is a CC signal comprises:
computing (1501) a CC detection variable;
determining (1503) if the CC detection variable is above a threshold value; and
responding to determining the CC detection variable is above the threshold, determining (1505) that the multi-channel audio signal is a CC signal.
   Embodiment 37. The apparatus (110, 120, 1000, 1006) of Embodiment 33 wherein determining if the CC detection variable is above the threshold value comprises determining if an absolute value of the CC detection variable is above the threshold value.
   Embodiment 38. The apparatus (110, 120, 1000, 1006) in any of Embodiments 34-37 wherein the memory includes further instructions that when executed by the processing circuitry causes the apparatus to filter the CC detection variable with low-pass filtering to stabilize the CC detection.
   Embodiment 39. The apparatus (110, 120, 1000, 1006) of Embodiment 38 wherein the low-pass filtering on the CC detection variable is adaptive, depending on at least an output A(m) of an activity detector.
   Embodiment 40. The apparatus (110, 120, 1000, 1006) of Embodiment 39 wherein filtering the CC detection variable with low-pass filtering comprises filtering with adaptive low-pass filtering in accordance with

$${D}_{LP} ( m ) = α ( m ) D ( m ) + ( 1 - α ( m ) ) {D}_{LP} ( m - 1 )$$

$$α ( m ) = \{ \begin{matrix}{α}_{high} , & A ( m ) = TRUE \\ {α}_{low} , & A ( m ) = FALSE\end{matrix}$$

where A(m) is the output of an activity detector and α_{high} and α_{low} are filter coefficients.
Embodiment 41. An apparatus (110, 120, 1000, 1006) adapted to:
for each frame m of a multi-channel audio signal:
   generate (1401) a cross-correlation of a channel pair of the multi-channel audio signal;
   determine (1403) a first ITD estimate based on the cross-correlation;
   determine (1405) if the multi-channel audio signal is a CC signal; and
   responsive to determining that the multi-channel audio signal is a CC signal, bias (1407) the ITD search to favor ITDs close to zero to obtain a final ITD.
      Embodiment 42. The apparatus (110, 120, 1000, 1006) of Embodiment 41, wherein the apparatus (110, 120, 1000, 1006) is adapted to perform according to Embodiments 2-20.
      Embodiment 43. A computer program comprising program code to be executed by processing circuitry (1201/1301) of an apparatus (110, 120, 1000, 1006), whereby execution of the program code causes the apparatus (110, 120, 1000, 1006) to:
for each frame m of a multi-channel audio signal:
   generate (1401) a cross-correlation of a channel pair of the multi-channel audio signal;
   determine (1403) a first ITD estimate based on the cross-correlation;
   determine (1405) if the multi-channel audio signal is a CC signal; and
   responsive to determining that the multi-channel audio signal is a CC signal, bias (1407) the ITD search to favor ITDs close to zero to obtain a final ITD.
      Embodiment 44. The computer program of Embodiment 43 wherein the program code comprises further program code to cause the apparatus (110, 120, 1000, 1006) to perform according to any of Embodiments 2-20.
      Embodiment 45. A computer program product comprising a non-transitory storage medium including program code to be executed by processing circuitry 1201/1301) of an apparatus (110, 120, 1000, 1006), whereby execution of the program code causes the apparatus (110, 120, 1000, 1006) to:
for each frame m of a multi-channel audio signal:
   generate (1401) a cross-correlation of a channel pair of the multi-channel audio signal;
   determine (1403) a first ITD estimate based on the cross-correlation;
   determine (1405) if the multi-channel audio signal is a CC signal; and
   responsive to determining that the multi-channel audio signal is a CC signal, bias (1407) the ITD search to favor ITDs close to zero to obtain a final ITD.
      Embodiment 46. The computer program of Embodiment 45 wherein the non-transitory storage medium includes further program code to cause the apparatus (110, 120, 1000, 1006) to perform according to any of Embodiments 2-20.

Explanations are provided below for various abbreviations/acronyms used in the present disclosure.

| Abbreviation | Explanation |
|---|---|
| CC | Coincident Microphone Configurations |
| ILD | inter-aural level difference or inter-channel level |
| | difference |
| ITD | inter-aural time difference or inter-channel time |
| | difference |
| IC or IACC | inter-aural coherence or correlation or inter-channel |
| | coherence or correlation |
| GCC | General Cross-Correlation |
| GCC-PHAT | Generalized Cross-Correlation with PHAse |
| | Transform |

1. A method to identify coincident microphone configurations, CC, and adapt an inter-channel time difference, ITD, search, in an encoder or a decoder, the method comprising:
for each frame m of a multi-channel audio signal:
generating a cross-correlation of a channel pair of the multi-channel audio signal;
determining a first ITD estimate based on the cross-correlation;
determining if the multi-channel audio signal is a CC signal; and
responsive to determining that the multi-channel audio signal is a CC signal, biasing the ITD search to favor ITDs close to zero to obtain a final ITD.

2. The method of claim 1, further comprising
responsive to determining that the multi-channel audio signal is not a CC signal, obtaining the final ITD without favoring ITDs close to zero.

3. The method of claim 2 wherein obtaining the final ITD when the multi-channel audio signal is not a CC signal comprises obtaining the final ITD by setting the final ITD to the first ITD estimate.

4. The method of claim 1, further comprising applying stabilization to an ITD to obtain the final ITD.

5. The method of claim 4, wherein applying stabilization further comprises generating at least one TTD candidate.

6. The method of claim 1, wherein biasing the ITD search to favor ITDs close to zero to obtain the final ITD comprises obtaining the final ITD by selecting an ITD having a smallest absolute value.

7. The method of claim 6 wherein selecting the ITD having the smallest absolute value comprises selecting the ITD as the final ITD in accordance with
$${ITD}_{1} ( m ) = \{ \begin{matrix}{ITD}_{stab} ( m ) , & CC detected , \vert {ITD}_{stab} ( m ) \vert < \vert {ITD}_{0} ( m ) \vert \\ {ITD}_{0} ( m ) , & CC detected , \vert {ITD}_{stab} ( m ) \vert \geq \vert {ITD}_{0} ( m ) \vert\end{matrix}$$
where ITD₁(m) is the final ITD, ITD₀(m) is the first ITD estimate, and ITD_{stab}(m) is a stabilized ITD.

8. The method of claim 1, wherein biasing the ITD search to favor ITDs close to zero comprises selecting the final ITD from ITD candidates within a limited range around zero.

9. The method of claim 1, wherein biasing the ITD search to favor ITDs close to zero to obtain the final ITD comprises applying a weighting of a cross-correlation to assign larger weight to values of the cross-correlation close to zero.

10. The method of claim 1, wherein determining the first ITD estimate comprises determining the first ITD estimate as an absolute maximum of the cross-correlation.

11. The method of claim 10, wherein determining the first ITD estimate as the absolute maximum of the cross-correlation comprises determining the absolute maximum in accordance with
$${ITD}_{0} ( m ) = arg {max}_{τ} ( \vert {r}_{xy}^{PHAT} ( τ ) \vert )$$
where ITD₀(m) is the first ITD estimate, r_{xy}^{PHAT}(τ) is the cross-correlation, and τ is a time-lag parameter.

12. The method in claim 1 where the cross-correlation is a generalized cross-correlation with phase transform (GCC-PHAT).

13. The method of claim 1 wherein determining if the multi-channel audio signal is a CC signal comprises:
detecting one of an anti-symmetric pattern and a symmetric pattern in the cross-correlation in the channel pair of the multi-channel audio signal.

14. The method of claim 13 wherein detecting the anti-symmetric pattern in the component comprises detecting the anti-symmetric pattern in accordance with
$$D ( m ) = - {r}_{xy}^{PHAT} ( {ITD}_{0} ( m ) ) \cdot {r}_{xy}^{PHAT} ( - {ITD}_{0} ( m ) )$$
where D(m) is a CC detection variable, r_{xy}^{PHAT} is the GCC-PHAT, and ITD₀(m) is the first ITD estimate.

15. The method of claim 13 wherein detecting the one of an anti-symmetric pattern and a symmetric pattern in the cross-correlation comprises detecting the anti-symmetric pattern in accordance with at least one of
$$D ( m ) = max ( 0 , {\sum }_{τ = 0}^{R} \vert {r}_{xy}^{PHAT} ( τ ) {r}_{xy}^{PHAT} ( - τ ) \vert ) ,$$
$$D ( m ) = max ( 0 , \frac{1}{R + 1} {\sum }_{τ = 0}^{R} \vert {r}_{xy}^{PHAT} ( τ ) {r}_{xy}^{PHAT} ( - τ ) \vert ) ,$$
$$D ( m ) = max ( 0 , {max}_{0 , τ = [ 0 , … , R ]} ( \vert {r}_{xy}^{PHAT} ( τ ) {r}_{xy}^{PHAT} ( - τ ) \vert ) )$$
$$D ( m ) = \frac{{\sum }_{τ = 1}^{R} {r}_{xy}^{PHAT} ( τ ) {r}_{xy}^{PHAT} ( - τ )}{\sqrt{{\sum }_{τ = 1}^{R} {( {r}_{xy}^{PHAT} ( τ ) )}^{2} {\sum }_{τ = 1}^{R} {( {r}_{xy}^{PHAT} ( - τ ) )}^{2}}}$$
$$D ( m ) = \frac{{\sum }_{τ = - W}^{W} {r}_{xy}^{PHAT} ( {ITD}_{0} ( m ) + τ ) {r}_{xy}^{PHAT} ( - {ITD}_{0} ( m ) + τ )}{{\sum }_{τ = - W}^{W} {( {r}_{xy}^{PHAT} ( {ITD}_{0} ( m ) + τ ) )}^{2}} , or$$
$$D ( m ) = \frac{- {r}_{xy}^{PHAT} ( {ITD}_{0}^{′} ( m ) ) \cdot {r}_{xy}^{PHAT} ( - {ITD}_{0}^{′} ( m ) )}{{{r}_{xy}^{PHAT} ( {ITD}_{0} ( m ) )}^{2}} ,$$
where D(m) is a CC detection variable, r_{xy}^{PHAT} is the GCC-PHAT, R is a search range, W defines a region around the first estimate of the ITD being matched, and ITD₀′(m) is an ITD candidate limited to the search range [−R, R].

16. The method of claim 1 wherein determining if the multi-channel audio signal is a CC signal comprises:
computing a CC detection variable;
determining if the CC detection variable is above a threshold value; and
responding to determining the CC detection variable is above the threshold, determining that the multi-channel audio signal is a CC signal.

17. The method of claim 16 wherein determining if the CC detection variable is above the threshold value comprises determining if an absolute value of the CC detection variable is above the threshold value.

18. The method in claim 14 further comprising filtering the CC detection variable with low-pass filtering to stabilize the CC detection.

19. The method of claim 18 wherein the low-pass filtering on the CC detection variable is adaptive, depending on at least an output A(m) of an activity detector.

20. The method of claim 19 wherein filtering the CC detection variable with low-pass filtering comprises filtering with adaptive low-pass filtering in accordance with
$${D}_{LP} ( m ) = α ( m ) D ( m ) + ( 1 - α ( m ) ) {D}_{LP} ( m - 1 )$$
$$α ( m ) = \{ \begin{matrix}{α}_{high} , & A ( m ) = TRUE \\ {α}_{low} , & A ( m ) = FALSE\end{matrix}$$
where A(m) is the output of an activity detector and α_{high} and α_{low} are filter coefficients.

21. An apparatus comprising:
processing circuitry; and
memory coupled with the processing circuitry, wherein the memory includes instructions that when executed by the processing circuitry causes the apparatus to:
for each frame m of a multi-channel audio signal:
generate a cross-correlation of a channel pair of the multi-channel audio signal;
determine a first ITD estimate based on the cross-correlation;
determine if the multi-channel audio signal is a CC signal; and
responsive to determining that the multi-channel audio signal is a CC signal, bias the ITD search to favor ITDs close to zero to obtain a final ITD.

22.-44. (canceled)

45. A computer program product comprising a non-transitory storage medium including program code to be executed by processing circuitry of an apparatus, whereby execution of the program code causes the apparatus to:
for each frame m of a multi-channel audio signal:
generate a cross-correlation of a channel pair of the multi-channel audio signal;
determine a first ITD estimate based on the cross-correlation;
determine if the multi-channel audio signal is a CC signal; and
responsive to determining that the multi-channel audio signal is a CC signal, bias the ITD search to favor ITDs close to zero to obtain a final ITD.

46. The computer program of claim 45 wherein the non-transitory storage medium includes further program code to cause the apparatus to perform operations of:
for each frame m of a multi-channel audio signal:
generating a cross-correlation of a channel pair of the multi-channel audio signal;
determining a first TTD estimate based on the cross-correlation;
determining if the multi-channel audio signal is a CC signal;
responsive to determining that the multi-channel audio signal is a CC signal, biasing the ITD search to favor ITDs close to zero to obtain a final ITD; and
responsive to determining that the multi-channel audio signal is not a CC signal, obtaining the final ITD without favoring ITDs close to zero.
